(19) United States
(12) Patent Application Publication
(10) Pub. No.: US 2025/0170890 A1
(43) Pub. Date: May 29, 2025

(54) SHIFT DEVICE

(71) Applicant: KABUSHIKI KAISHA TOKAI-RIKA-DENKI-SEISAKUSHO, Aichi (JP)

(72) Inventors: Hironori WATANABE, Niwa-gun, Aichi (JP); Hironori MIZUNO, Niwa-gun, Aichi (JP); Norihiro YAMAMURA, Niwa-gun, Aichi (JP)

(73) Assignee: KABUSHIKI KAISHA TOKAI-RIKA-DENKI-SEISAKUSHO, Aichi (JP)

(21) Appl. No.: 18/843,540

(22) PCT Filed: Feb. 27, 2023
(86) PCT No.: PCT/JP2023/007159

§ 371 Date: Sep. 3, 2024

(30) Foreign Application Priority Data
Mar. 4, 2022 (JP) 2022-033885

(51) Int. Cl. B60K 20/06

(52) U.S. Cl. CPC B60K 20/06

(57) ABSTRACT

In a shift device, a lever is turned to rotate a rotating body, whereby a link is rotated, and a detection shaft is rotated. Furthermore, a magnetic sensor detects a rotational position of the detection shaft. Here, a rotating shaft direction of the rotating body and a rotating shaft direction of the detection shaft are not parallel, and the link transmits the rotation from the rotating body to the detection shaft. Therefore, the rotating body and the detection shaft can be connected via the link, and the degree of freedom of the connection structure between the rotating body and the detection shaft can be increased.

### TECHNICAL FIELD

The present invention relates to a shift device in which a shift body is moved to change a shift position.

### BACKGROUND ART

In a remote shift switching device described in US 2020/0292064 A, a rotary knob is rotated to rotate a rotary block (including a rotary transfer driving part), and the rotary block is rotated to rotate a rotary transfer shaft (including a rotary transfer driven part). Furthermore, a rotational position of the rotary transfer shaft is detected.

Here, in the remote shift switching device, a rotating shaft direction of the rotary block and a rotating shaft direction of the rotary transfer shaft are not parallel, and the rotary transfer driving part of the rotary block and the rotary transfer driven part of the rotary transfer shaft are connected while constituting a gear mechanism.

### SUMMARY OF INVENTION

### Technical Problem

In view of the above fact, an object of the present invention is to obtain a shift device capable of increasing the degree of freedom of a connection structure between a rotating body and a detection body.

### Solution to Problem

A shift device according to a first aspect of the present invention includes: a shift body that is moved to change a shift position; a rotating body that is rotated by movement of the shift body; a detection body having a rotating shaft direction that is not parallel to a rotating shaft direction of the rotating body and whose rotational position is detected; and a transmitter that transmits rotation from the rotating body to the detection body.

A shift device according to a second aspect of the present invention is the shift device according to the first aspect of the present invention, in which the transmitter and one of the rotating body or the detection body are connected while constituting a link mechanism, and the transmitter and another of the rotating body or the detection body are connected while constituting a gear mechanism.

A shift device according to a third aspect of the present invention is the shift device according to the first or second aspect of the present invention, in which a connection position of the transmitter with the rotating body is different from a connection position of the transmitter with the detection body in a rotating shaft direction of the transmitter.

A shift device according to a fourth aspect of the present invention is the shift device according to any one of the first to third aspects of the present invention, in which the transmitter amplifies rotation of the detection body with respect to rotation of the rotating body.

### Advantageous Effects of Invention

In the shift device according to the first aspect of the present invention, the shift body is moved to change a shift position. In addition, the shift body is moved to rotate the rotating body, and the transmitter transmits the rotation from the rotating body to the detection body. Furthermore, a rotational position of the detection body is detected.

Here, the rotating shaft direction of the rotating body and the rotating shaft direction of the detection body are not parallel, and the transmitter transmits the rotation from the rotating body to the detection body. Therefore, the rotating body and the detection body can be connected via the transmitter, and the degree of freedom of the connection structure between the rotating body and the detection body can be increased.

In the shift device according to the second aspect of the present invention, the transmitter and one of the rotating body or the detection body are connected while constituting a link mechanism, and the transmitter and the other of the rotating body or the detection body are connected while constituting a gear mechanism. Therefore, the transmitter can connect the rotating body and the detection body.

In the shift device according to the third aspect of the present invention, a connection position of the transmitter with the rotating body is different from a connection position of the transmitter with the detection body in a rotating shaft direction of the transmitter. Therefore, the degree of freedom of a relative position between the rotating body and the detection body can be increased.

In the shift device according to the fourth aspect of the present invention, the transmitter amplifies rotation of the detection body with respect to rotation of the rotating body. Therefore, a rotation amount of the detection body with respect to a movement amount of the shift body can be increased, and accuracy of detecting a movement position of the shift body on the basis of a rotational position of the detection body can be increased.

### BRIEF DESCRIPTION OF DRAWINGS

FIG. 1A is a perspective view illustrating a shift device according to an embodiment of the present invention as viewed from a left oblique rear side.

FIG. 1B is a perspective view illustrating the shift device according to the embodiment of the present invention as viewed from an upper oblique right side.

FIG. 2A is a perspective view illustrating a main part of the shift device according to the embodiment of the present invention as viewed from a left oblique rear side.

FIG. 2B is a perspective view illustrating the main part of the shift device according to the embodiment of the present invention as viewed from a left oblique front side.

FIG. 3A is a perspective view illustrating a rotating body and a link of the shift device according to the embodiment of the present invention as viewed from a lower oblique front side.

FIG. 3B is a perspective view illustrating a fixed frame of the rotating body of the shift device according to the embodiment of the present invention as viewed from a lower oblique front side.

FIG. 3C is a perspective view illustrating a piece of the rotating body of the shift device according to the embodiment of the present invention as viewed from a lower oblique rear side.

FIG. 3D is a perspective view illustrating a link of the shift device according to the embodiment of the present invention as viewed from an upper oblique rear side.

FIG. 4A is a rear view illustrating a state where a lever is disposed at an “H” position as viewed from a rear in the shift device according to the embodiment of the present invention.

FIG. 4B is a perspective view illustrating a state where the lever is disposed at the “H” position as viewed from a left oblique rear side in the shift device according to the embodiment of the present invention.

FIG. 4C is a top view illustrating a state where the lever is disposed at the “H” position as viewed from a top in the shift device according to the embodiment of the present invention.

FIG. 4D is a bottom view illustrating a state where the lever is disposed at the “H” position as viewed from a bottom in the shift device according to the embodiment of the present invention.

FIG. 5A is a rear view illustrating a state where the lever is disposed at an “R” position as viewed from a rear in the shift device according to the embodiment of the present invention.

FIG. 5B is a perspective view illustrating a state where the lever is disposed at the “R” position as viewed from a left oblique rear side in the shift device according to the embodiment of the present invention.

FIG. 5C is a top view illustrating a state where the lever is disposed at the “R” position as viewed from a top in the shift device according to the embodiment of the present invention.

FIG. 5D is a bottom view illustrating a state where the lever is disposed at the “R” position as viewed from a bottom in the shift device according to the embodiment of the present invention.

FIG. 6A is a rear view illustrating a state where the lever is disposed at a “D” position as viewed from a rear in the shift device according to the embodiment of the present invention.

FIG. 6B is a perspective view illustrating a state where the lever is disposed at the “D” position as viewed from a left oblique rear side in the shift device according to the embodiment of the present invention.

FIG. 6C is a top view illustrating a state where the lever is disposed at the “D” position as viewed from a top in the shift device according to the embodiment of the present invention.

FIG. 6D is a bottom view illustrating a state where the lever is disposed at the “D” position as viewed from a bottom in the shift device according to the embodiment of the present invention.

### DESCRIPTION OF EMBODIMENTS

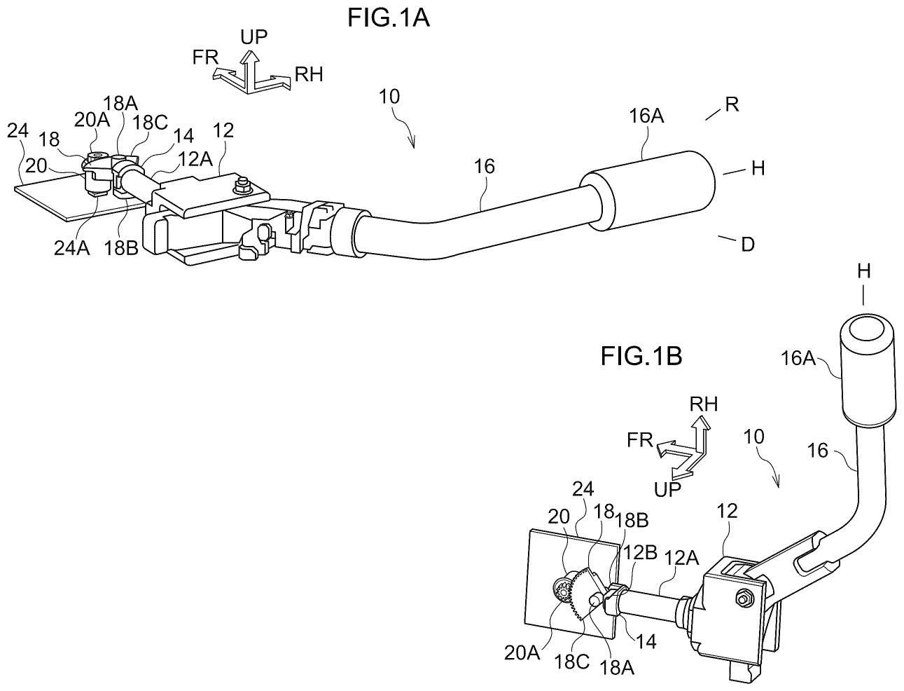

FIG. 1A illustrates a perspective view of a shift device 10 according to an embodiment of the present invention as viewed from a left oblique rear side, and FIG. 1B illustrates a perspective view of the shift device 10 as viewed from an upper oblique right side. Note that, in the drawings, a front side of the shift device 10 is indicated by an arrow FR, a right side of the shift device 10 is indicated by an arrow RH, and an upper side of the shift device 10 is indicated by an arrow UP.

The shift device 10 according to the present embodiment is disposed in a steering column (not illustrated) of a vehicle (automobile), and a front side, a right side, and an upper side of the shift device 10 are directed to a front side, a right side, and an upper side of the vehicle, respectively.

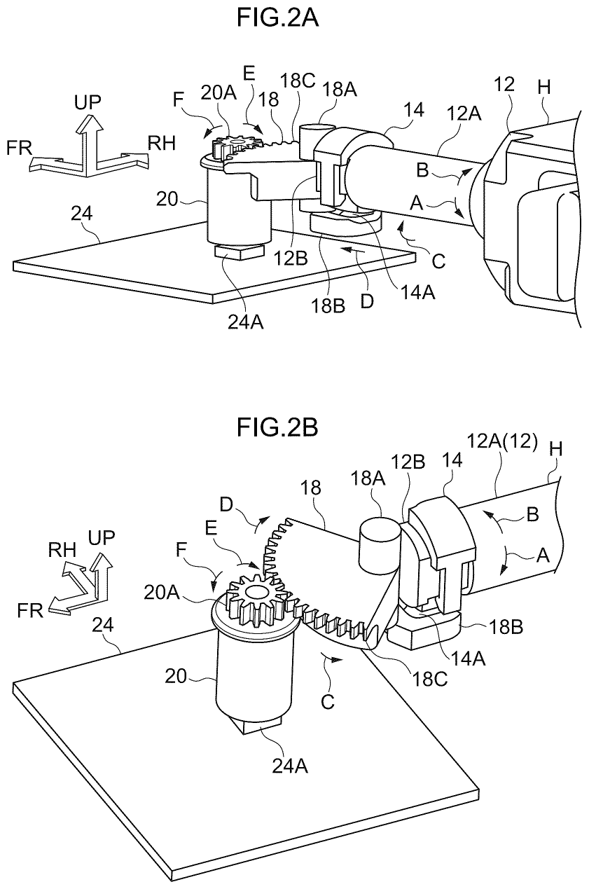

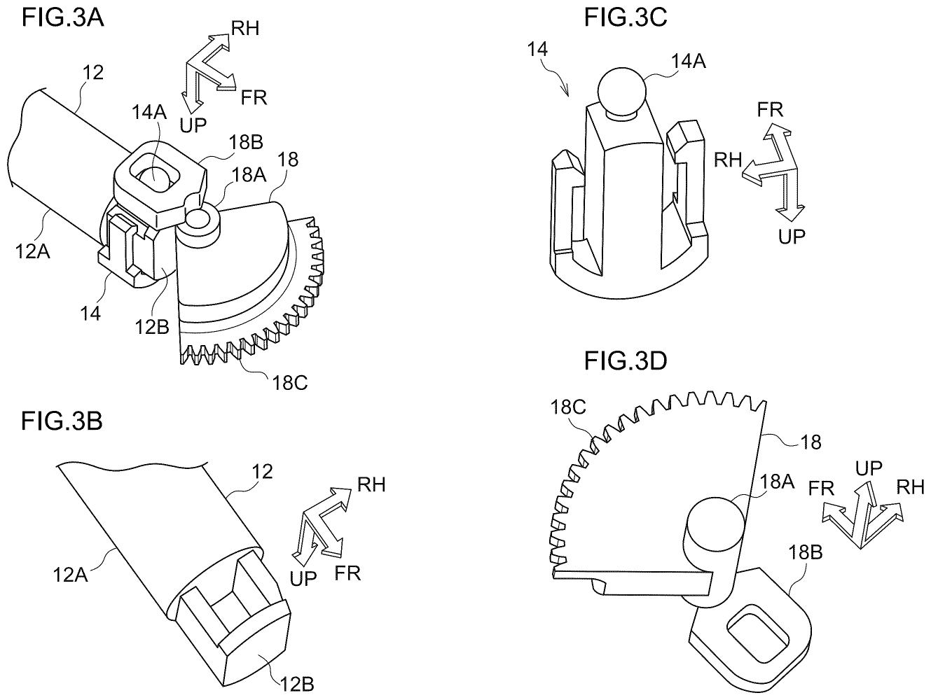

As illustrated in FIGS. 1A and 1B, the shift device 10 includes a rotating body 12 (see FIGS. 2A and 2B), and a columnar rotating shaft 12A is disposed at a front portion of the rotating body 12. An axial direction of the rotating shaft 12A is a front-rear direction, and the rotating body 12 is supported so as to be rotatable about the rotating shaft 12A as a central axis. A U-shaped fixed frame 12B (see FIG. 3B) is integrally disposed on a front side of the rotating shaft 12A, and the inside of the fixed frame 12B is opened in an up-down direction.

A piece 14 (see FIGS. 3A and 3C) having a substantially E-shaped cross section as a first connecting portion is attached to the fixed frame 12B of the rotating body 12, and an upper wall of the piece 14 is disposed above the fixed frame 12B, and movement of the piece 14 downward with respect to the fixed frame 12B is locked. A central portion of the piece 14 is extended downward from the upper wall of the piece 14 and has a rectangular columnar shape. The central portion of the piece 14 is fitted into the fixed frame 12B, and movement of the piece 14 in a front-rear direction and a left-right direction with respect to the fixed frame 12B is locked. A left portion and a right portion of the piece 14 are extended downward from the upper wall of the piece 14, and hook portions are formed at lower end portions of the left portion and the right portion. The hook portions of the left portion and the right portion of the piece 14 are hooked on a left portion and a right portion of the fixed frame 12B, respectively, and movement of the piece 14 upward with respect to the fixed frame 12B is locked. As a result, the piece 14 is fixed to the fixed frame 12B and integrally rotated with the rotating body 12. A spherical connection ball 14A is integrally disposed below the central portion of the piece 14.

A proximal end portion (front end portion) of a substantially rod-shaped lever 16 as a shift body is connected to a rear portion of the rotating body 12, and the lever 16 can be turned (moved) integrally with the rotating body 12 about the rotating shaft 12A as a central axis. An intermediate portion of the lever 16 is extended in a direction toward a rear side as it goes to a right side, and a distal end side portion (rear side portion) of the lever 16 is extended to the right side. A substantially columnar knob 16A as a grip portion is disposed at a distal end portion of the lever 16, and the knob 16A is disposed in a vehicle interior. An occupant (in particular, a driver) of the vehicle can perform a turning operation on the lever 16 upward and downward in the knob 16A. The lever 16 is turned upward to rotate the rotating body 12 in an arrow A direction (see FIGS. 2A and 2B and the like). The lever 16 is turned downward to rotate the rotating body 12 in an arrow B direction (see FIGS. 2A and 2B and the like).

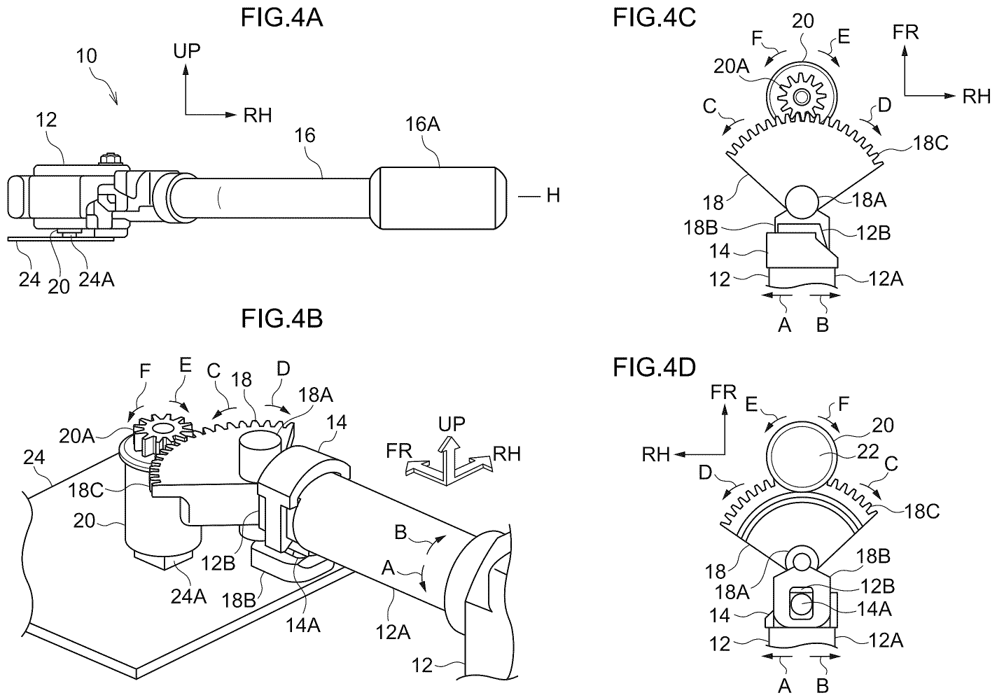

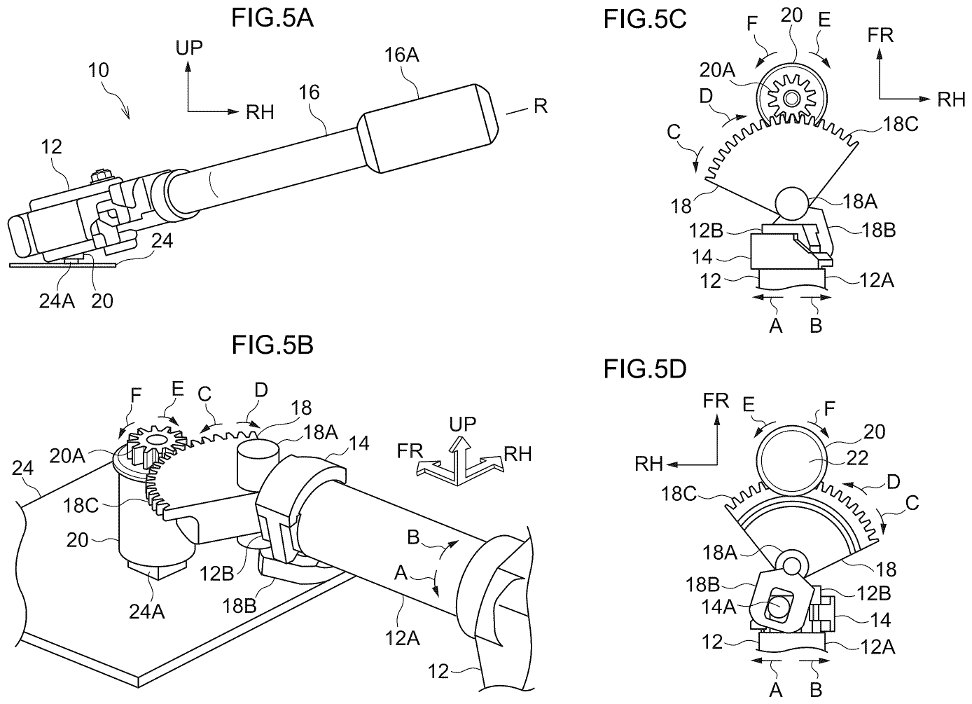

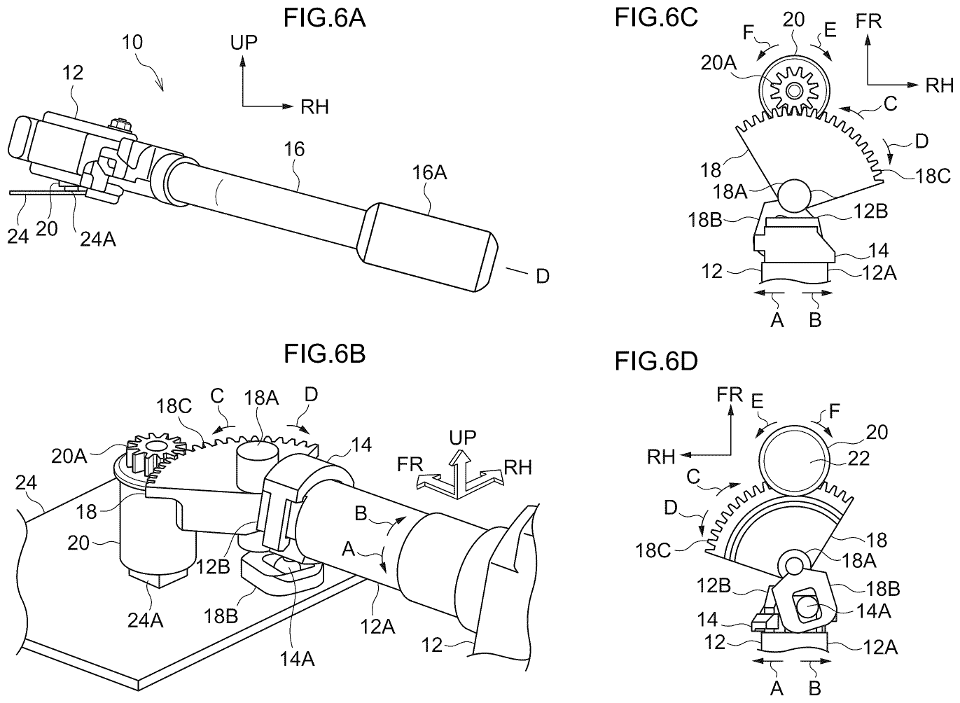

The lever 16 is disposed at an “H” position (home position) as a shift position (see FIG. 4A). The lever 16 is turned upward from the “H” position to be disposed at an “R” position (reverse position) as a shift position (see FIG. 5A). The lever 16 is turned downward from the “H” position to be disposed at a “D” position (drive position) as a shift position (see FIG. 6A). The lever 16 is biased to the “H” position side from the “R” position and the “D” position. When action of an operating force on the lever 16 is released in a state where the lever 16 is operated to a position other than the “H” position, the lever 16 is turned (returned) to the “H” position by a biasing force.

A link 18 (see FIGS. 3A and 3D) as a transmitter is disposed on a front side of the rotating body 12, and the link 18 has a substantially columnar link shaft 18A as a transmission shaft. An axial direction of the link shaft 18A is an up-down direction, and the link 18 is supported so as to be rotatable about the link shaft 18A as a central axis.

A substantially rectangular link frame 18B as a first connected portion is integrally disposed at a lower end of the link shaft 18A. The link frame 18B protrudes toward a rear side and has an inside opened in an up-down direction. The connection ball 14A of the rotating body 12 (piece 14) is inserted into the link frame 18B from above. The connection ball 14A is fitted into the link frame 18B in a left-right direction and is relatively movable in a front-rear direction with respect to the inside of the link frame 18B. When the rotating body 12 is rotated in the arrow A direction, the link frame 18B is rotated to a right side by rotation of the connection ball 14A, and the link 18 is rotated in an arrow C direction (see FIGS. 2A and 2B and the like). When the rotating body 12 is rotated in the arrow B direction, the link frame 18B is rotated to a left side by rotation of the connection ball 14A, and the link 18 is rotated in an arrow D direction (see FIGS. 2A and 2B and the like). A rotation radius of the link frame 18B at a contact position with the connection ball 14A is smaller than a rotation radius of the connection ball 14A at the contact position with the link frame 18B, and rotation (rotation angle) of the link 18 is amplified with respect to rotation (rotation angle) of the rotating body 12.

A substantially fan-shaped plate-shaped link gear 18C (spur gear) as a second connecting portion is integrally disposed at an intermediate portion of the link shaft 18A in an up-down direction. The link gear 18C protrudes toward a front side and is disposed perpendicularly to the up-down direction.

A substantially columnar detection shaft 20 (see FIGS. 2A and 2B) as a detection body is disposed on a front side of the link 18, and the detection shaft 20 is rotatably supported with its axial direction being an up-down direction. A detection gear 20A (spur gear) as a second connected portion is coaxially disposed at an upper end portion of the detection shaft 20, and the link gear 18C of the link 18 is meshed with the detection gear 20A. When the link 18 is rotated in the arrow C direction, the detection gear 20A is rotated by rotation of the link gear 18C, and the detection shaft 20 is rotated in an arrow E direction (see FIGS. 2A and 2B and the like). When the link 18 is rotated in the arrow D direction, the detection gear 20A is rotated by rotation of the link gear 18C, and the detection shaft 20 is rotated in an arrow F direction (see FIGS. 2A and 2B and the like). A rotation radius of the detection gear 20A at a meshing position with the link gear 18C is smaller than a rotation radius of the link gear 18C at the meshing position with the detection gear 20A, and rotation (rotation angle) of the detection shaft 20 is amplified with respect to rotation (rotation angle) of the link 18.

A disk-shaped magnet 22 (see FIG. 4D) as a unit to be detected is coaxially disposed at a lower end portion of the detection shaft 20, and the magnet 22 is fixed in a state of being inserted into the detection shaft 20.

A detection substrate 24 (see FIGS. 2A and 2B) as a detection device is disposed below the detection shaft 20, and the detection substrate 24 is disposed perpendicularly to an up-down direction. A magnetic sensor 24A having a substantially rectangular plate shape as a detection unit is fixed to an upper surface of the detection substrate 24. The magnetic sensor 24A is disposed immediately below the magnet 22 of the detection shaft 20, and is disposed such that an upper surface thereof is parallel to the magnet 22. The magnetic sensor 24A has a detection surface (not illustrated). By detecting a direction of a magnetic field generated by the magnet 22 on the detection surface, the magnetic sensor 24A detects a rotational position of the magnet 22 and detects a rotational position of the detection shaft 20. The detection surface is disposed in parallel to an upper surface of the magnetic sensor 24A and disposed in parallel to the magnet 22. As a result, detection accuracy of the rotational position of the magnet 22 by the magnetic sensor 24A is increased, and detection accuracy of the rotational position of the detection shaft 20 is increased.

Next, an operation of the present embodiment will be described.

In the shift device 10 having the above structure, the lever 16 is turned to change a shift position of the lever 16. In addition, the lever 16 is turned to rotate the rotating body 12, whereby the link 18 is rotated, and the detection shaft 20 is rotated (see FIGS. 4A to 4D, 5A to 5D, and 6A to 6D). Furthermore, the magnetic sensor 24A of the detection substrate 24 detects a rotational position of the detection shaft 20 (magnet 22), whereby a rotational position of the link 18, a rotational position of the rotating body 12, and a turning position of the lever 16 are detected, and a shift position of the lever 16 is detected.

Here, the rotating shaft direction of the rotating body 12 and the rotating shaft direction of the detection shaft 20 are not parallel, and the link 18 transmits the rotation from the rotating body 12 to the detection shaft 20. Therefore, the rotating body 12 and the detection shaft 20 can be connected via the link 18, it is not necessary to directly connect the rotating body 12 and the detection shaft 20, and the degree of freedom of the connection structure between the rotating body 12 and the detection shaft 20 can be increased.

In addition, the rotating body 12 (piece 14) and the link 18 (link frame 18B) are connected while constituting a link mechanism, and the link 18 (link gear 18 C) and the detection shaft 20 (detection gear 20 A) are connected while constituting a gear mechanism. Therefore, the link 18 can transmit the rotation from the rotating body 12 to the detection shaft 20. In addition, unlike a case where the rotating body 12 and the detection shaft 20 are directly connected while constituting a worm wheel and a worm, the connection structure between the rotating body 12 and the detection shaft 20 can be downsized.

Furthermore, the connection position of the link 18 with the rotating body 12 (the position of the link frame 18B) is different from the connection position of the link 18 with the detection shaft 20 (the position of the link gear 18C) in the rotating shaft direction of the link 18. Therefore, it is possible to increase the degree of freedom of a relative position between the connection ball 14A of the piece 14 in the rotating body 12 and the detection gear 20A of the detection shaft 20, and it is possible to increase the degree of freedom of a relative position between the rotating body 12 and the detection shaft 20.

In addition, rotation of the link 18 is amplified with respect to rotation of the rotating body 12, and rotation of the detection shaft 20 is amplified with respect to rotation of the link 18. Therefore, a rotation amount of the detection shaft 20 with respect to a turning amount of the lever 16 can be increased, detection accuracy of a turning position of the lever 16 based on detection of a rotational position of the detection shaft 20 (magnet 22) by the magnetic sensor 24A can be increased, and detection accuracy of a shift position of the lever 16 can be increased.

Note that, in the present embodiment, rotation of the link 18 is amplified with respect to rotation of the rotating body 12, and rotation of the detection shaft 20 is amplified with respect to rotation of the link 18. However, at least one of the rotation of the link 18 with respect to the rotation of the rotating body 12 or the rotation of the detection shaft 20 with respect to the rotation of the link 18 only needs to be amplified.

In addition, in the present embodiment, the rotating body 12 and the link 18 are connected while constituting a link mechanism. However, the rotating body 12 and the link 18 may be connected while constituting a gear mechanism.

Furthermore, in the present embodiment, the link 18 and the detection shaft 20 are connected while constituting a gear mechanism. However, the link 18 and the detection shaft 20 may be connected while constituting a link mechanism.

In addition, in the present embodiment, the lever 16 is biased to the “H” position side. However, the lever 16 may be biased to each shift position side.

Furthermore, in the present embodiment, the lever 16 (shift body) is turned. However, the shift body may be rotated about a central axis or slid (moved). When the shift body is slid, the shift body and the rotating body 12 may constitute a rack and a pinion, whereby the shift body may be slid to rotate the rotating body 12.

In addition, in the present embodiment, the shift device 10 is disposed in the steering column. However, the shift device 10 may be disposed in another portion (such as an instrument panel or a console) of the vehicle.

The whole of the disclosure of Japanese Patent Application No. 2022-33885 filed on Mar. 4, 2022 is incorporated herein by reference.

### REFERENCE SIGNS LIST

10 Shift device
12 Rotating body
16 Lever (shift body)
18 Link (transmitter)
20 Detection shaft (detection body)

1. A shift device comprising:
a shift body that is moved to change a shift position;
a rotating body that is rotated by movement of the shift body;
a detection body having a rotating shaft direction that is not parallel to a rotating shaft direction of the rotating body and whose rotational position is detected; and
a transmitter that transmits rotation from the rotating body to the detection body.

2. The shift device according to claim 1, wherein the transmitter and one of the rotating body or the detection body are connected while constituting a link mechanism, and the transmitter and another of the rotating body or the detection body are connected while constituting a gear mechanism.

3. The shift device according to claim 1, wherein a connection position of the transmitter with the rotating body is different from a connection position of the transmitter with the detection body in a rotating shaft direction of the transmitter.

4. The shift device according to claim 1, wherein the transmitter amplifies rotation of the detection body with respect to rotation of the rotating body.

5. The shift device according to claim 4, wherein rotation of the transmitter is amplified with respect to the rotation of the rotating body, and the rotation of the detection body is amplified with respect to the rotation of the transmitter.

6. The shift device according to claim 1, wherein a position of the rotating body and a position of the detection body coincide with each other in a rotating shaft direction of the transmitter.
